(19) United States
(12) Patent Application Publication
(10) Pub. No.: US 2015/0220886 A1
(43) Pub. Date: Aug. 6, 2015

(54) DOCKETING SYSTEM AND METHOD FOR SCHEDULING A COURT HEARING

(71) Applicant: Solid Design Software Solution LLC d/b/a SolidCircle, Holland, MI (US)

(72) Inventors: Pranay Rajgarhia, Zeeland, MI (US); James Garrett Brown, Grand Haven, MI (US); Douglas Edward MacDonald, Grand Rapids, MI (US)

(73) Assignee: Solid Design Software Solution LLC d/b/a SolidCircle

(21) Appl. No.: 14/590,496

(22) Filed: Jan. 6, 2015

Related U.S. Application Data
(60) Provisional application No. 61/935,988, filed on Feb. 5, 2014.

(51) Int. Cl. G06Q 10/10; G06Q 50/18; G06F 17/30; H04L 29/08; H04L 29/06

(52) U.S. Cl. CPC G06Q 10/1095; H04L 67/02; H04L 67/42; G06F 17/30867; G06Q 50/18

(57) ABSTRACT

A docketing system is disclosed herein. The system includes a web server hosting a web based application program and coupled to a database server in which hearing schedule data is stored. The web based application is configured to receive a search request and process the hearing schedule data stored on the database server to return a search result. The search request is characterized by search criteria submitted from a client device in communication with the web server and the search result is supplied to the client device and indicates one or more available time slots in which to schedule a hearing.

### CROSS-REFERENCE TO RELATED APPLICATION

This application claims benefit to U.S. Provisional Patent Application No. 61/935,988, filed Feb. 5, 2014, and entitled “DOCKETING SYSTEM AND METHOD FOR SCHEDULING A COURT HEARING,” the entire disclosure of which is hereby incorporated herein by reference.

### FIELD OF THE INVENTION

The disclosure made herein relates generally to docketing systems and methods for accomplishing the same, and more particularly to a docketing system and method for scheduling a court hearing.

### BACKGROUND OF THE INVENTION

The process of scheduling a court hearing can be cumbersome. Thus, there is a need for an efficient and practical means to do so.

### SUMMARY OF THE INVENTION

According to one aspect of the present invention, a docketing system is provided. The system includes a web server hosting a web based application program and coupled to a database server in which hearing schedule data is stored. The web based application is configured to receive a search request and process the hearing schedule data stored on the database server to return a search result. The search request is characterized by search criteria submitted from a client device in communication with the web server and the search result is supplied to the client device and indicates one or more available time slots in which to schedule a hearing.

According to another aspect of the present invention, a docketing method for scheduling a court hearing is provided. The method is implemented by a web based application program hosted on a web server. The web server is coupled to a database server in which hearing schedule data is stored. The method includes the steps of: receiving a search request from a client device in communication with the web server, wherein the search request is characterized by search criteria submitted from the client device; processing the hearing schedule data based on the search criteria; and returning a search result indicating one or more available time slots in which to schedule a hearing, wherein the search result is supplied to the client device.

According to a further aspect of the present invention, a non-transitory computer readable medium having stored thereon software instructions executed by a processor is provided. The software instructions are implemented by a web based application program and include the steps of: receiving a search request from a client device in communication with a web server that hosts the web based application and is coupled to a database server on which hearing schedule data is stored, wherein the search request is characterized by search criteria submitted from the client device; processing the hearing schedule data based on the search criteria; and returning a search result indicating one or more available time slots in which to schedule a hearing, wherein the search result is supplied to the client device.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 shows the overall architecture of a docketing system used to schedule a court hearing, according to one embodiment of the present invention;

FIG. 2 shows a user interface implemented as a webpage that allows a user to provide input to the system and receive output from the same;

FIG. 3 shows a search method for identifying available time slots in which to schedule a court hearing; and

FIG. 4 shows a hearing request window that can be deployed by a scheduling module.

### DETAILED DESCRIPTION OF THE PREFERRED EMBODIMENTS

While various aspects of the inventive subject matter are described with reference to a particular illustrative embodiment, the inventive subject matter is not limited to such embodiments, and additional modifications, applications, and embodiments may be implemented without departing from the inventive subject matter. In the figures, like reference numbers will be used to illustrate the same components. Those skilled in the art will recognize that the various components set forth herein may be altered without varying from the scope of the inventive subject matter.

The present invention provides a docketing system and method that allows a user to quickly and efficiently schedule a hearing. The docketing system and method described herein is particularly useful for personnel (e.g. a docket clerk) that are responsible for various clerical duties in a particular court of law. When managing a hearing schedule, such personnel may interact with attorneys, public officials, and other interested parties, each having their own requests and needs. In response to such a scenario, conventional docketing practices may require personnel to utilize a wide range of informational resources embodied in various formats (e.g. electronic, paper, etc.) in order to properly retrieve scheduling information and/or schedule a hearing. The employ of such practices not only takes up time, but also increases the chance for error. Recognizing this, the docketing system and method described herein greatly simplifies the process of retrieving scheduling information and/or scheduling a hearing by providing an intuitive tool that is advantageously implemented through web based programming, as will now be described in greater detail.

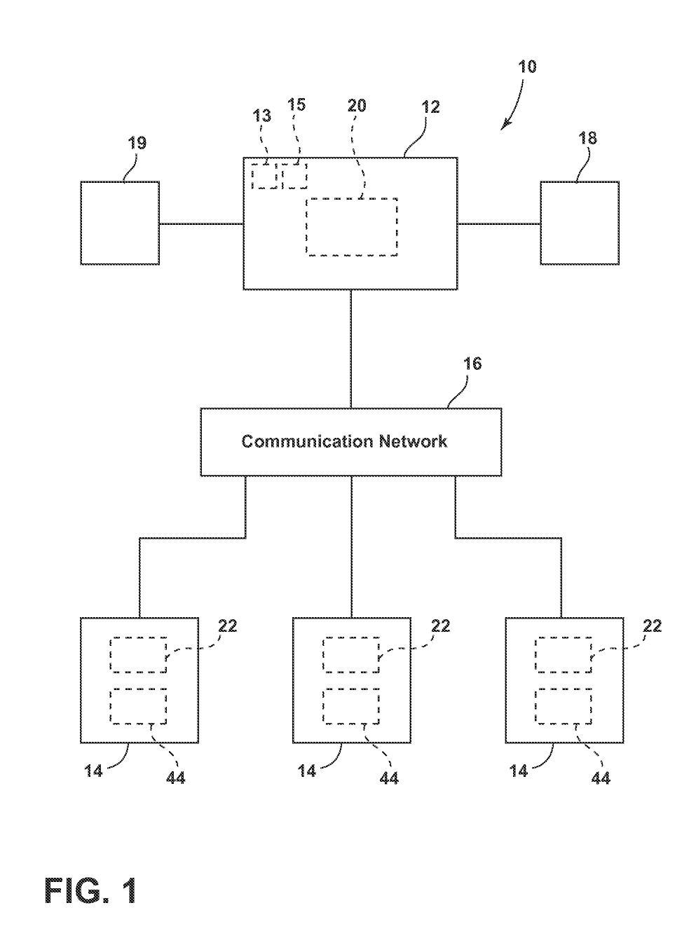

FIG. 1 generally illustrates the overall architecture of a docketing system 10 according to one embodiment. As shown, the docketing system 10 includes a web server 12 coupled to one or more client devices 14 via a communication network 16. The web server 12 can include a processor 13 for executing instructions stored on a non-transitory computer readable medium 15 (e.g. a memory). The web server 12 is coupled to a database server 18 that stores data containing information related to hearing schedules for one or more participants and can be integrated with external calendaring systems 19 belonging to each participant. According to one embodiment, the web server 12 hosts a web based application program 20 that can be accessed over the communication network 16 via a web browser 22 running on a given client device 14. Communication network 16 can be any suitable communication network such as, but not limited to, the Internet, a local area network (LAN), a wide area network (WAN), and the like. It should be appreciated that the communication network 16 can be wireless or wired and can be configured to be private or public. Web browser 22 can be any conventional web browser such as, but not limited to, Microsoft Internet Explorer®, Google Chrome®, Mozilla Firefox®, and Apple Safari®. It is well known that such web browsers are generally compatible with various operating platforms, thereby allowing web based application program 20 to be easily deployed and accessed by a diverse selection of client devices 14, which may include desktops, laptops, netbooks, and smart devices such as cellular phones, tablets, and the like.

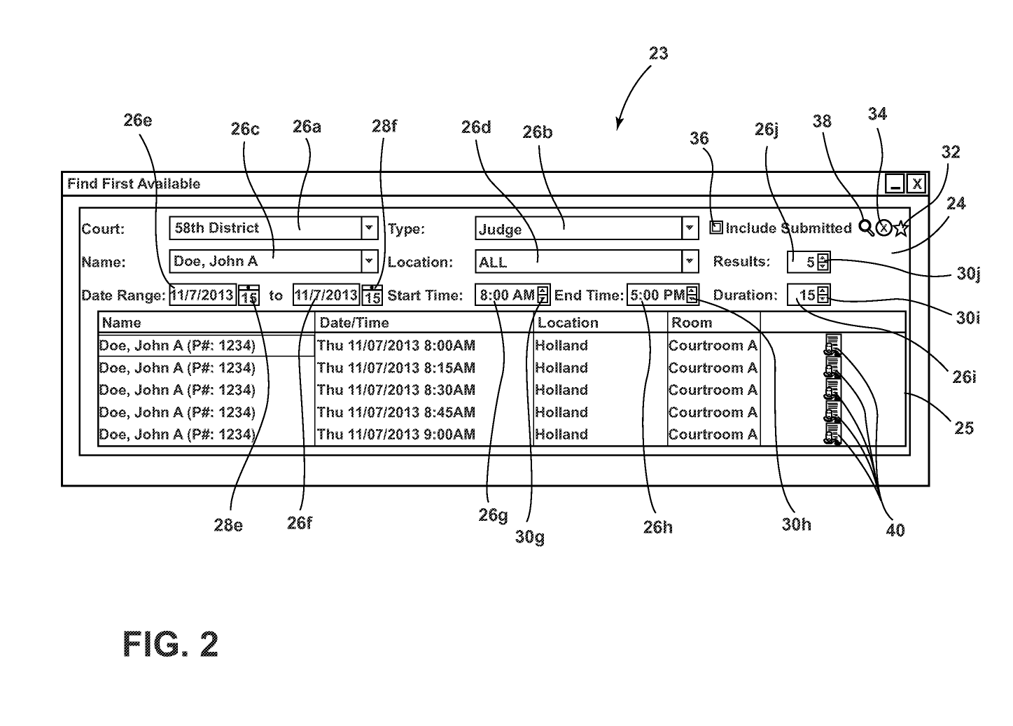

The web based application program 20 is configured to deploy a user interface 23, such as the one shown in FIG. 2, which is rendered on a screen of the client device 14. User interface 23 can be implemented as a web page, which the web browser 22 can retrieve over the communication network 16 using the web page's Uniform Resource Locator (URL) or other address identifier. In one embodiment, a user may first be required to login before access to the user interface 23 is granted. Additionally, or alternatively, user interface 23 can be launched from a corresponding menu or submenu option on the web page. As described in greater detail below, user interface 23 can be configured to allow a user to provide input and receive output from the docketing system 10.

With reference to FIG. 2, user interface 23 generally includes an input window 24 for receiving user input and an output window 25 for displaying search results. As shown, input window 24 includes one or more input fields for receiving input from a user, wherein each input field relates to relevant search criteria that can be used when performing a search to determine the availability of one or more participants for the purposes of scheduling a hearing. According to the illustrated embodiment, input fields 26a-26d allow a user to make a court of law selection, a participant type selection, a participant selection, and a location selection, respectively. Like its name implies, the court of law selection (input field 26a) allows a user to specify a court of a particular jurisdiction including, but not limited to, district courts, circuit courts (e.g. juvenile services, trial division), and probate courts. The participant type selection (input field 26b) allows the user to specify a particular type of participant associated with the judicial process that may be required to attend the hearing. Such participants can include, but are not limited to, judges, magistrates, referees, probation officers, caseworkers. The participant selection (input field 26c) allows the user to specify the particular participant by his or her name. Lastly, the location selection (input field 26d) allows the user to specify a particular geographical location in which the hearing is desired to take place.

Each input field 26a-26d can be implemented as a drop-down window that allows a user to make one or more selections therefrom. In addition, each input field 26a-26d includes an ALL selection that is provided as a default selection to enable a user to search across all available selections, which can be particularly beneficial when a selection does not matter or a user is unsure as to which selection to make. In some instances, a user's selection(s) in one or more of the input fields 26a-26d can auto-populate other input fields 26a-26d. For example, if a user specifies a district court in input field 26a, input field 26c can auto-populate with only the names of participants associated with the district court. Likewise, input fields 26b and 26d may also undergo auto-population to reflect the selection of the district court in input field 26a, if applicable. Logically, it follows that subsequent selections made in either one of input fields 26b, 26c, and 26d can further refine the search criteria. For example, if the user specifies a type in input field 26b, the available selections in input field 26c may be further reduced to having only the names of participants associated with the district court for the specified type.

Referring still to FIG. 2, user interface 23 can also include input fields 26e and 26f, which correspond to a start date selection and an end date selection, respectively. Input fields 26e and 26f enable a user to specify a date range in which the user desires to schedule a hearing and can both be implemented as text boxes, each having the current date as a default selection. If a different date range is desired, a user can input the desired start date and/or end date in the appropriate text box using whatever inputting means are available to the client device. Alternatively, the start and/or end date can be determined by opening a corresponding calendar pop-up window (not shown) via calendar pop-up icons 28e and 28f, and selecting a desired date using the appropriate calendar pop up window. The selected date may then be reflected in the appropriate text box of input fields 26e and 26f.

Along with being able to specify a date range, a user can also be given the option of specifying a time range. As shown in FIG. 2, user interface 23 can further include input fields 26g and 26h, which correspond to a start time selection and an end time selection, respectively, and can both be implemented as text boxes requiring user input. Alternatively, the user can make a desired time selection by incrementing or decrementing whatever time is displayed in one or both text boxes via an up-down control feature 30g, 30h associated with the corresponding text box of input fields 26g and 26h, respectively. In the event a user does not specify a time in the text box of input field 26g and/or input field 26h, a default time reflecting regular hours of operation (e.g. 8:00 AM to 5:00 PM), a previous time range set by the user, or some other time range can be displayed in the appropriate text box and utilized when performing the search. As is further shown in FIG. 2, user interface 23 can further include input fields 26i and 26j, which allow a user to specify a desired hearing duration and a desired number of search results, respectively. Both input fields 26i and 26j can be implemented as text boxes requiring user input and can additionally include an up-down control feature 30i, 30j associated therewith. For purposes of illustration, input field 26i is shown having a default duration of 15 minutes and input field 26j is shown having a default search return that is limited to a maximum of five results.

Once each of the input fields 26a-26j have been filled with either user provided input or a default selection, a user can click favorites icon 32 to save (e.g. bookmark) the current search criteria so that it can be easily retrieved at a later time. As an optional feature, user interface 23 can be auto-populated with saved search criteria upon screen launch. The saved search criteria can correspond to the last saved search or one that the user selects as a default. If at any time during a search, a user desires to return input fields 26a-26j to an original default setting or a user-specified default setting, the user can click the clear icon 34 located next to the favorites icon 32. Lastly, a user can also decide whether a search should include hearing requests that have been submitted and are pending approval by checking checkbox 36, which is typically unchecked by default.

To request a search, a user clicks on search icon 38, causing the web based application program 20 to read in the search criteria found in input fields 26a-26j and store the same in instance variables. The web based application program 20 polls the database server 18 to receive a hearing schedule blueprint based on the search criteria. The polling process includes integration to each selected participant's personal calendar, which can include external calendaring systems (e.g. Lotus Notes), to find scheduled items to be included in data processing, thereby creating a dynamic hearing schedule blueprint that contains each participant's schedule and changes therewith. For data processing purposes, the web based application program 20 can implement instructions stored on a non-transitory computer readable medium and executable by a processor (e.g. processor 13). The instructions, when executed by the processor, cause the web based application program 20 to implement one of four search algorithms based on the number of participants specified in input field 26c and attributes associated with the data received while polling the database server 18. Specifically, a first search algorithm is executed when more than one participant is specified in input field 26c and data received during polling indicates the presence of one or more scheduled hearings during the selected date and time range, as specified in input fields 26e-26h, respectively. A second search algorithm is executed when more than one participant is specified in input field 26c and data received during polling does not indicate the presence of any scheduled hearings during the selected date and time range, as specified in input fields 26e-26h, respectively. A third search algorithm is executed when a single participant is specified in input field 26c and data received during polling indicates the presence of one or more scheduled hearings during the selected date and time range, as specified in input fields 26e-26h, respectively. Finally, a fourth search algorithm is executed when a single participant is specified in input field 26c and data received during polling does not indicate the presence of any scheduled hearings during the selected date and time range, as specified in input fields 26e-26h, respectively. By categorizing the search algorithms in this manner, each search algorithm can be optimized to handle its corresponding data.

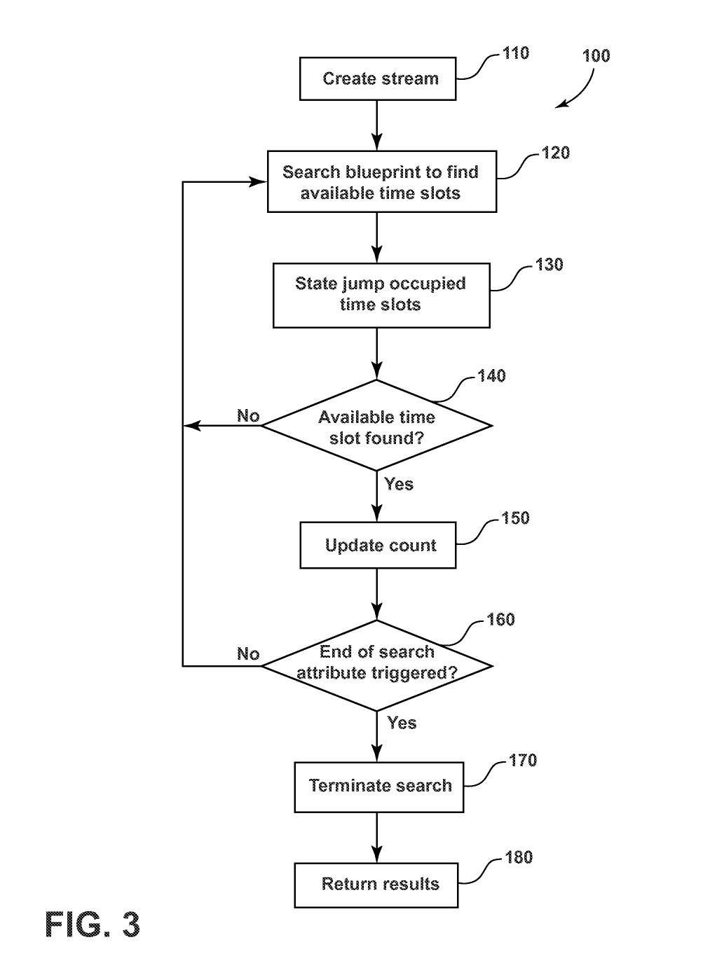

Moving forward, each search algorithm will now be described with reference to a search method 100 shown in FIG. 3. Discussion now turns to the first search algorithm, which begins at step 110, where the web based application program 20 implements a stream for each selected participant that processes the hearing schedule blueprint received from polling the database server 18. As previously mentioned, the first search algorithm executes when more than one participant is specified in input field 26c and data received from the database server 18 indicates the presence of one or more scheduled hearings during the selected date and time range, as specified in input fields 26e-26h, respectively. In view of the foregoing, when the first search algorithm is executed, multiple streams are created, one for each selected participant. In step 120, each stream processes the hearing schedule blueprint to determine if the associated participant has any available time slots during the specified date and time range that coincide with the desired duration specified in input field 26i. In this case, the hearing schedule blueprint is concurrently processed, which allows each participant's calendar to be searched at the same time. In step 130, occupied time slots (e.g. previously scheduled hearings or pending hearing requests) for any given participant can be used as anchors to allow the corresponding stream to state jump in order to quickly process the hearing schedule blueprint provided by the database server 18. If a stream finds an available time slot in step 140, a count stored in a global variable can be updated accordingly, in step 150, which provides notice to the other streams that an available time slot has been identified for a particular date. Optionally, the stream can set an anchor for the available time slot identified in step 150, which are incorporated into the other streams, informing them to move past the identified time slot, even if it's available, so as not to return the same value. In this manner, each result returned to the user will have a unique time slot associated with a single participant.

After identifying an available time slot, the stream checks if an end of search attribute has been triggered in step 160. The end of search attribute can be triggered once the required available time slots have been identified. For example, the stream can check if the count value is equal to the number of desired results specified in input field 26j. Additionally or alternatively, the end of search attribute can also be triggered once all the streams have finished processing the hearing schedule blueprint (e.g. specified end date and time have been reached). In either event, if the end of search attribute has been triggered, the first search algorithm can be terminated in step 170, thereby stopping any active streams, if applicable. The results can then be returned to the user in step 180. In the event where all streams have run their course and the required number of available time slots has not been met, the first search algorithm can be terminated and the results, if any, are returned to the user. If the end of search attribute has not been triggered in step 160, the first search algorithm can return to step 120 so that the stream can continue processing the hearing schedule blueprint to find more available time slots for its corresponding participant. Through the use of parallel handlers, the results can be returned in the proper order even though the streams are searching concurrently and can be at different processing states.

Discussion now turns to the second search algorithm, which, as described previously, is executed when more than one participant is specified in input 26c and data received while polling the database server 18 does not indicate the presence of one or more scheduled hearings during the selected date and time range, as specified in input fields 26e-26h, respectively. Like the first search algorithm, the second search algorithm can begin at step 110, where the web based application program 20 implements a stream for each selected participant and each stream concurrently processes the hearing schedule blueprint so that each participant's calendar can be searched at the same time. In step 120, each stream processes the hearing schedule blueprint to determine if the associated participant has any available time slots during the specified date and time range that coincide with the desired duration specified in input field 26i. Since the hearing schedule blueprint associated with the second search algorithm is devoid of scheduled hearings, the lack of occupied time slots prevents any of the streams from state jumping within the hearing schedule blueprint to expedite the search process, thus skipping step 130 altogether. With the exception of the foregoing distinction, the second search algorithm generally proceeds in a similar fashion to the first search algorithm. For instance, if an available time slot is identified in step 140, the count value can be updated accordingly in step 150. If the end of search attribute is triggered in step 160, the second search algorithm can be terminated in step 170, thereby stopping all streams, if applicable, and returning the results to the user (step 260). If the end of search attribute has not been triggered in step 160, the second search algorithm can return to step 120 to continue processing the hearing schedule blueprint to identify any available time slots and automatically terminates when the required number of available time slots is found (e.g. the count value equals the desired number of results specified in input field 26j) and/or when all of the streams have run their course (e.g. specified end date and time have been reached). The results, if any, can then be returned to the user in the appropriate order.

Next, discussion turns to the third search algorithm, which, as described previously, is executed when a single participant is specified in input field 26c and data received while polling the database server 18 indicates the presence of one or more scheduled hearings during the selected date and time range, as specified in input fields 26e-26h, respectively. Since only one participant was specified in input field 26c, the web based application program 20 implements a single stream in step 110 to process the hearing schedule blueprint associated with that participant's calendar. In step 120, the stream processes the hearing schedule blueprint to determine if the participant has any available time slots during the specified date and time range that coincide with the desired duration specified in input field 26i. While searching for available time slots, the stream can state jump any occupied time slots in the participant's calendar in order to quickly process the hearing schedule blueprint in step 130. If the stream identifies an available time slot in step 140, the count value can be updated accordingly in step 150. If the end of search attribute is triggered in step 160, the third search algorithm can be terminated in step 170, thereby stopping all streams, if applicable, and returning the results to the user in step 180. If the end of search attribute has not been triggered in step 160, the third search algorithm returns to step 120 to continue processing the hearing schedule blueprint to identify any available time slots and automatically terminates when the required number of available time slots is found (e.g. the count value equals the desired number of results specified in input field 26j) and/or when the stream has ran its course (e.g. specified end date and time have been reached). The results, if any, can then be returned to the user in the appropriate order.

Finally, discussion turns to the fourth search algorithm, which, as previously described, is executed when a single participant is specified in input field 26c and data received while polling the database server 18 does not indicate the presence of any scheduled hearings during the selected date and time range, as specified in input fields 26e-26h, respectively. The fourth search algorithm can begin at step 110, and like the third search algorithm, since only one participant was specified in input field 26c, the web based application program 20 implements a single stream to process the hearing schedule blueprint associated with that participant's calendar. In step 120, the stream processes the hearing schedule blueprint to determine if the participant has any available time slots during the specified date and time range that coincide with the desired duration specified in input field 26i. With respect to the fourth search algorithm, step 130 is not performed since the hearing schedule blueprint associated with the fourth search algorithm is devoid of scheduled hearings. As a result, the lack of occupied time slots prevents the stream from state jumping within the hearing schedule blueprint to expedite the search process. With the exception of the foregoing distinction, the fourth search algorithm generally proceeds in a similar fashion to the third search algorithm. For instance, if the stream identifies an available time slot in step 140, the count value can be updated accordingly in step 150. Subsequently, if the end of search attribute is triggered in step 160, the third search algorithm can be terminated in step 170, thereby stopping all streams, if applicable, and returning the results to the user in step 180. If the end of search attribute has not been triggered in step 160, the fourth search algorithm returns to step 120 to continue processing the hearing schedule blueprint to identify any available time slots and automatically terminates when the required number of available time slots is found (e.g. the count value equals the desired number of results specified in input field 26j) and/or when the stream has ran its course (e.g. specified end date and time have been reached). The results, if any, can then be returned to the user in the appropriate order.

Regarding each of the search algorithms described herein, it should be appreciated that a stream for an associated participant can be split into multiple streams with the intention of identifying as many available time slots for that participant in a short amount of time. For instance, a stream can be split into multiple streams, each processing the hearing schedule blueprint concurrently. The number of multiple streams can correspond to the desired number of results specified in input 26j. In this manner, each of the multiple streams is responsible for finding one available time slot, if available, and can automatically stop when an available time slot is identified. By utilizing multiple streams for each selected participant, the computational search time needed to process the results can be significantly reduced.

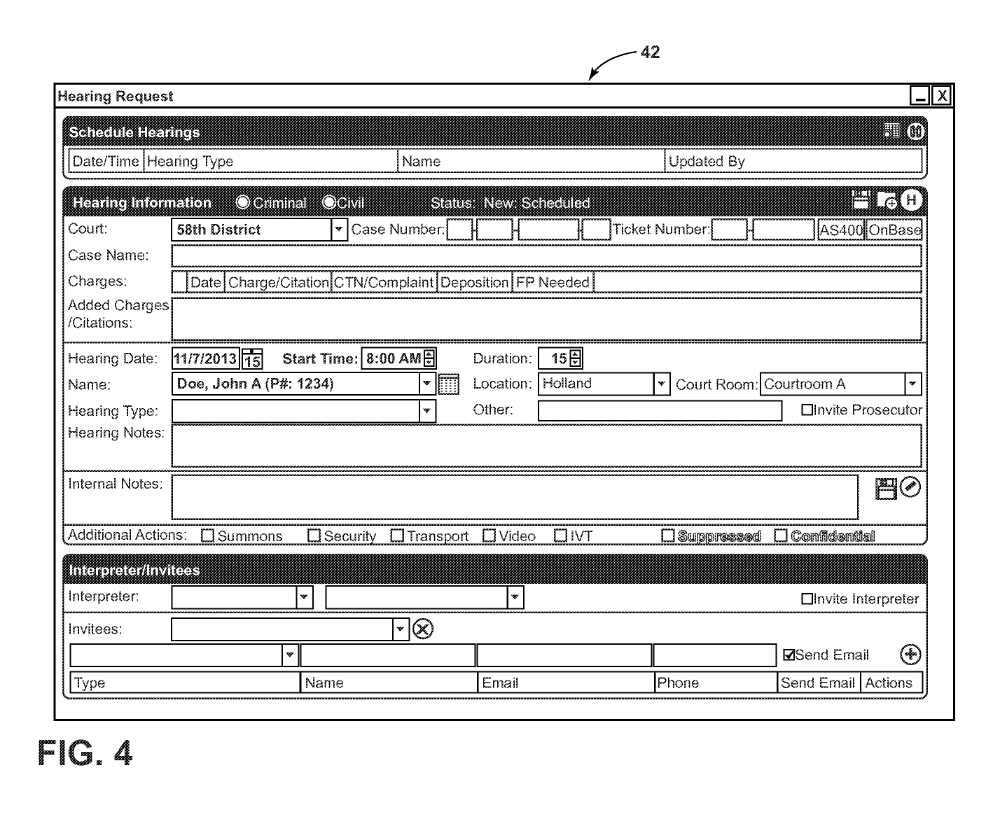

Referring back to FIG. 2, the search results can be returned in output window 25 and are limited to the number specified in input field 26j. In the illustrated embodiment, the search results are ordered based on availability, where the earliest available time slot is listed first by participant name, date/time, location, and courtroom. Each available time slot also includes a corresponding hearing request icon 40 that, when clicked, opens a hearing request window 42, which is shown in FIG. 4. The hearing request window 42 can be deployed by a scheduling module 44 (FIG. 1) running on the client device 14. If the scheduling module 44 is not currently running when the user clicks on the hearing request icon 40, then doing so can initiate a call to open and begin running the scheduling module 44 for user convenience. As shown, the hearing request window 42 can include a variety of input fields, some of which can be auto-populated using previously specified search criteria and/or information from the search return, which aids to expedite the filling of the request. The remaining input fields can allow a user to specify other useful information such as a case number, a ticket number, a case name, one or more charges/citations, a hearing type, hearing notes, internal notes, an interpreter selection, an invitee selection, as exemplarily shown in FIG. 4.

Accordingly, a docketing system and method have been advantageously described herein, which enables a hearing schedule to be scheduled in an efficient and practical manner. While the system and method have been described herein as being used in the legal industry, it should be appreciated that the system and method can be applied to other industries as well.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A docketing system comprising:
a web server hosting a web based application program and coupled to a database server in which hearing schedule data is stored, the web based application configured to receive a search request and process the hearing schedule data stored on the database server to return a search result, wherein the search request is characterized by search criteria submitted from a client device in communication with the web server and the search result is supplied to the client device and indicates one or more available time slots in which to schedule a hearing.

2. The docketing system of claim 1, wherein the search criteria is chosen from a group comprising: a court of law selection, a participant type selection, a participant selection, a location selection, a date range selection, a time range selection, a duration selection, and a results selection.

3. The docketing system of claim 2, wherein the web based application program implements a search algorithm based on how many participants are specified in the participant selection and whether the hearing schedule data indicates the presence of a scheduled hearing.

4. The docketing system of claim 2, wherein a number of available time slots returned in the search result is based on how many results are specified in the results selection and each available time slot corresponds in time with a duration specified in the duration selection and is displayed on the client device in an order ranging from a first available time slot to a last available time slot.

5. The docketing system of claim 1, wherein the web based application is configured to deploy a user interface that is rendered on the client device.

6. The docketing system of claim 5, wherein the user interface comprises an input window having a plurality of input fields for specifying the search criteria and an output window for displaying the search result.

7. The docketing system of claim 6, wherein the user interface further comprises a hearing request icon that opens a hearing request window.

8. A docketing method for scheduling a court hearing and implemented by a web based application program hosted on a web server that is coupled to a database server in which hearing schedule data is stored, comprising the steps of: receiving a search request from a client device in communication with the web server, wherein the search request is characterized by search criteria submitted from the client device; processing the hearing schedule data based on the search criteria; and returning a search result indicating one or more available time slots in which to schedule a hearing, wherein the search result is supplied to the client device.

9. The docketing method of claim 8, further comprising the step of generating a hearing request window in response to a user selecting an available time slot.

10. The docketing method of claim 8, wherein the search criteria is chosen from a group comprising: a court of law selection, a participant type selection, a participant selection, a location selection, a date range selection, a time range selection, a duration selection, and a results selection.

11. The docketing method of claim 10, wherein a number of available time slots is determined based on a number of results specified in the results selection and the number of available time slots are returned in an order ranging from a first available time slot to a last available time slot and each of the number of available time slot corresponds in time to a duration specified in the duration selection.

12. The docketing method of claim 10, wherein the web based application program implements a search algorithm based on how many participants are specified in the participant selection and whether the hearing schedule data indicates the presence of a scheduled hearing.

13. The docketing method of claim 12, wherein the web based application program implements: a first search algorithm when a plurality of participants are specified in the participant selection and the hearing schedule data indicates the presence of at least one scheduled hearing; a second search algorithm when a plurality of participants is specified in the participant selection and the hearing schedule data does not indicates the presence of a scheduled hearing; a third search algorithm when a single participant is specified in the participant selection and the hearing schedule data indicates the presence of at least one scheduled hearing; and a fourth search algorithm when a single participant is specified in the participant selection and the hearing schedule data does not indicate the presence of a scheduled hearing.

14. A non-transitory computer readable medium having stored thereon software instructions executed by a processor, the software instructions being implemented by a web based application program and comprising the steps of: receiving a search request from a client device in communication with a web server that hosts the web based application and is coupled to a database server on which hearing schedule data is stored, wherein the search request is characterized by search criteria submitted from the client device; processing the hearing schedule data based on the search criteria; and returning a search result indicating one or more available time slots in which to schedule a hearing, wherein the search result is supplied to the client device.

15. The non-transitory computer readable medium of claim 14, wherein the software instructions further comprise the step of generating a hearing request window in response to a user selecting an available time slot.

16. The non-transitory computer readable medium of claim 14, wherein the search criteria is chosen from a group comprising: a court of law selection, a participant type selection, a participant selection, a location selection, a date range selection, a time range selection, a duration selection, and a results selection.

17. The non-transitory computer readable medium of claim 16, wherein the software instructions further comprise the step of identifying a number of available time slots based on a number of results specified in the results selection.

18. The non-transitory computer readable medium of claim 17, wherein the number of available time slots are returned in an order ranging from a first available time slot to a last available time slot and each of the number of available time slot corresponds in time to a duration specified in the duration selection.

19. The non-transitory computer readable medium of claim 16, wherein the software instruction further comprise the step of implementing a search algorithm based on how many participants are specified in the participant selection and whether the hearing schedule data indicates the presence of a scheduled hearing.

20. The non-transitory computer readable medium of claim 19, wherein a first search algorithm is implemented when a plurality of participants are specified in the participant selection and the hearing schedule data indicates the presence of at least one scheduled hearing; a second search algorithm is implemented when a plurality of participants is specified in the participant selection and the hearing schedule data does not indicates the presence of a scheduled hearing; a third search algorithm is implemented when a single participant is specified in the participant selection and the hearing schedule data indicates the presence of at least one scheduled hearing; and a fourth search algorithm is implemented when a single participant is specified in the participant selection and the hearing schedule data does not indicate the presence of a scheduled hearing.
